(19) United States
(12) Patent Application Publication
(10) Pub. No.: US 2008/0235041 A1
(43) Pub. Date: Sep. 25, 2008

(54) Enterprise data management

(76) Inventors: Jeffrey J. Cashdollar, Goodlettsville, TN (US); J. Michael Smith, Nashville, TN (US); Patrick R. Clark, Cottontown, TN (US); Michael D. Sanders, College Grove, TN (US)

Correspondence Address: CATERPILLAR/FINNEGAN, HENDERSON, L.L.P., 901 New York Avenue, NW, WASHINGTON, DC, 20001-4413, US

(21) Appl. No.: 11/723,736

(22) Filed: Mar. 21, 2007

(51) Int. Cl. G06Q 10/00

(52) U.S. Cl. 705/1

(57) ABSTRACT

Methods and systems manage data for an enterprise. In one implementation, a computer-implemented method is provided for managing data for an enterprise. According to the method, data may be imported from a plurality of data sources into a staging area of a server. In the staging area, the data may be processed. The processing may comprise determining a category identifier for a subset of the data based on one of the plurality of data sources from which the subset of the data originated and assigning the category identifier to the subset of the data. The method may further comprise transmitting the subset of the data from the staging area to a work area of the server and applying, by the work area, one or more logical rules to the subset of the data based on the category identifier. The one or more logical rules may convert the subset of the data. The method further comprises storing the subset of the data in a database.

### TECHNICAL FIELD

The present disclosure relates generally to enterprise data management, and more particularly, to a system and computer-implemented method that classify and convert data from multiple sources.

### BACKGROUND

In businesses, such as enterprises, large quantities of data are stored and used in daily business operations. As a result, many situations exist in which data that is stored for one purpose is accessed for another purpose. For example, a company that manufactures and sells products might store manufacturing data related to the products that are produced by the company. At a later time, a different unit of the company, such as an insurance unit, might sell a service contract or extended warranty for one or more of the products. The insurance unit might access the manufacturing data in order to identify the product or products for purposes of underwriting the service contract or extended warranty. However, the manner in which the data was stored by the manufacturing unit might make it difficult for the insurance unit to use the data. That is, because the data was created for manufacturing purposes, the data might not easily transfer to another purpose. For example, the manufacturing data might be stored using codes and/or identifiers that are not appropriate or applicable for insurance purposes. Furthermore, the manufacturing data may be incomplete or not properly categorized for insurance purposes.

In particular, insurance is highly regulated and detailed reports are often required in the insurance industry. These reports must include accurate data. However, since manufacturing data is often incomplete or inappropriate for insurance reporting purposes, companies frequently manually re-enter the data when generating insurance reports. Manual re-entry is necessary for a variety of reasons. For example, the insurance unit of the company may not have access to the manufacturing data, may not understand the manufacturing data, or may not have enough confidence in the accuracy of the manufacturing data. As a result, resources are often expended in order to manually reclassify and process data that was already classified by another part of the company. In today's business world, such repetition and inefficiencies lead to wasted time and resources.

U.S. Pat. No. 6,873,997 (the '997 patent) to Maijasie et al. discloses a data management system for automatically propagating information to disparate information systems from a central location. According to the '997 patent, the data management system includes a server that extracts, formats, and transmits changes in data stored in a central database to a user system. However, the system of the '997 patent does not provide functionality for automatically converting data from internal and external sources into a standardized format that is suitable for a particular purpose, such as insurance reporting. Furthermore, the system of the '997 patent does not provide functionality for classifying the data according to its source and using that classification to further process the data.

The disclosed embodiments are directed to overcoming one or more of the problems set forth above.

### SUMMARY OF THE INVENTION

In one aspect, the present disclosure is directed to a computer-implemented method for managing data for an enterprise. According to the method, data may be imported from a plurality of data sources into a staging area of a server. In the staging area, the data may be processed. The processing may comprise determining a category identifier for a subset of the data based on one of the plurality of data sources from which the subset of the data originated and assigning the category identifier to the subset of the data. The method may further comprise transmitting the subset of the data from the staging area to a work area of the server and applying, by the work area, one or more logical rules to the subset of the data based on the category identifier. The one or more logical rules may convert the subset of the data. The method further comprises storing the subset of the data in a database.

In another aspect, the present disclosure is directed to a system for managing data for an enterprise. The system may include a data warehouse server. The data warehouse server may comprise a staging area operable to import data from a plurality of data sources; determine a category identifier for a subset of the data based on one of the plurality of data sources from which the subset of the data originated; and assign the category identifier to the subset of the data. The data warehouse server may further include a work area operable to receive the subset of the data from the staging area and apply one or more logical rules to the subset of the data based on the category identifier. The one or more logical rules may convert at least a portion of the subset of the data. The system may further include a database that stores the subset of the data after processing by the staging area and the work area.

It is to be understood that both the foregoing general description and the following detailed description are exemplary and explanatory only and are not restrictive of the invention or embodiments thereof, as claimed.

### BRIEF DESCRIPTION OF THE DRAWINGS

The accompanying drawings, which are incorporated in and constitute a part of this disclosure, illustrate various embodiments. In the drawings:

FIG. 1 is an exemplary system for managing and integrating data, consistent with a disclosed embodiment;

FIG. 2 is an exemplary software architecture for implementing data management functionality for a data warehouse server, consistent with a disclosed embodiment; and

FIG. 3 is a flow diagram of an exemplary method for implementing data management functionality for the data warehouse server, consistent with a disclosed embodiment.

### DETAILED DESCRIPTION

Reference will now be made in detail to the following exemplary embodiments, which are illustrated in the accompanying drawings. Wherever possible, the same reference numbers will be used throughout the drawings to refer to the same or like parts.

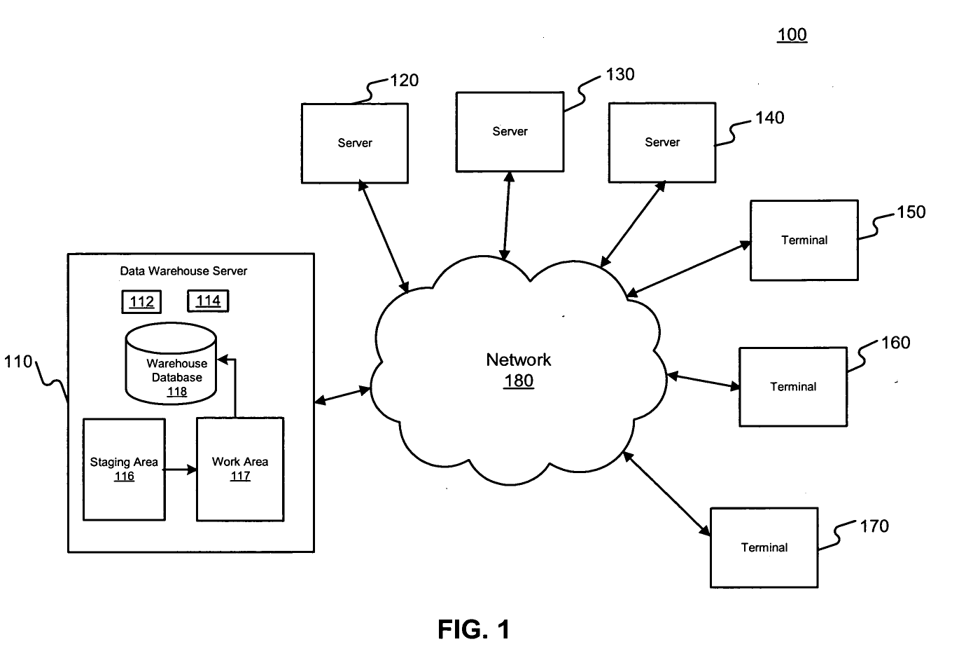

FIG. 1 is an exemplary system 100 for managing enterprise data, consistent with a disclosed embodiment. In particular, system 100 may classify, convert, and store data received from multiple systems. System 100 may further apply logical rules in order to process the data so that it is more suitable for a particular purpose, such as, for example, insurance reporting. As shown in system 100, data warehouse server 110, servers 120, 130, and 140, and terminals 150, 160, and 170 are connected to a network 180. One of skill in the art will appreciate that although one data warehouse server, three servers, and three terminals are depicted in FIG. 1, any number of these components may be provided. Furthermore, one of ordinary skill in the art will recognize that functions provided by one or more components of system 100 may be combined.

Network 180 provides communications between the various entities in system 100, such as data warehouse server 110, servers 120-140, and terminals 150-170. In addition, data warehouse server 110, servers 120-140, and terminals 150-170 may access legacy systems (not shown) via network 180, or may directly access legacy systems, databases, or other network applications. Network 180 may be a shared, public, or private network, may encompass a wide area or local area, and may be implemented through any suitable combination of wired and/or wireless communication networks. Furthermore, network 180 may comprise a local area network (LAN), a wide area network (WAN), an intranet, or the Internet.

Data warehouse server 110 may comprise a general purpose computer (e.g., a personal computer, network computer, server, or mainframe computer) having a processor 112 that may be selectively activated or reconfigured by a computer program. Data warehouse server 110 may also be implemented in a distributed network. For example, data warehouse server 110 may communicate via network 180 with one or more additional servers (not shown), which may enable data warehouse server 110 to distribute a process for parallel execution by a plurality of servers. Alternatively, data warehouse server 110 may be specially constructed for carrying-out methods consistent with the disclosed embodiment.

Data warehouse server 110 may include a memory 114 for storing program modules that, when executed by processor 112, perform one or more processes. Memory 114 may be one or more memory devices that store data as well as software. Memory 114 may also comprise one or more of RAM, ROM, magnetic storage, or optical storage, for example.

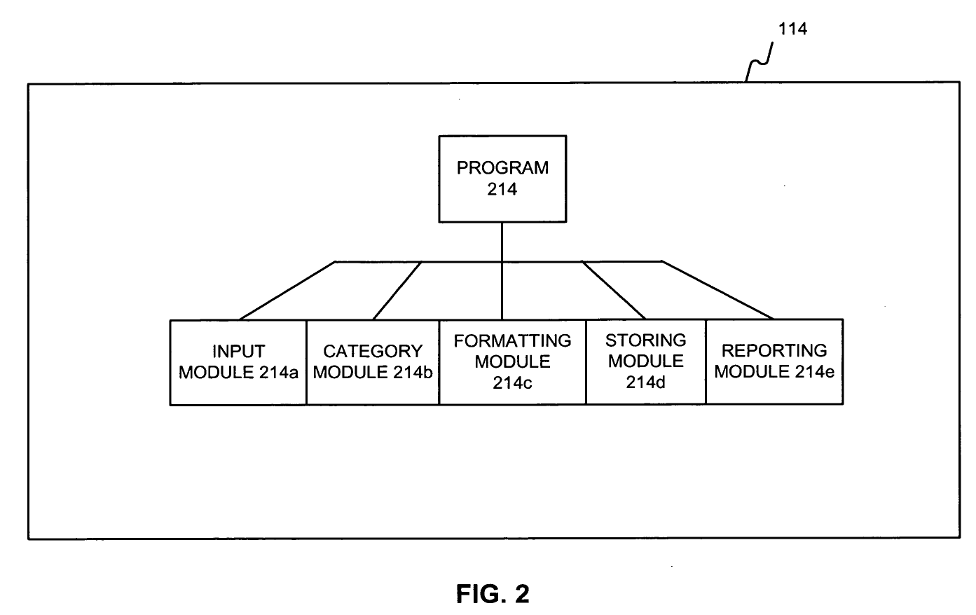

Data received by data warehouse server 110 may initially enter a staging area 116. For example, data transmitted to data warehouse server 110 may be formatted in one or more predetermined formats. Staging area 116 may comprise a memory storing program instructions for processing the received data. Processing operations performed by staging area 116 may include extracting, auditing, and/or archiving the received data. For example, staging area 116 may extract a subset of data from the received data for further processing and/or storage. Staging area 116 may audit the received data or a subset of the received data. In addition, staging area 116 may archive the received data or a subset of the received data. For example, staging area 116 may include a staging database (not shown), which may store data in staging tables. The staging tables may comprise data previously processed by staging area 116. Data stored in the staging tables may be further processed by staging area 116 at a later time. Furthermore, applications that are external to data warehouse server 110 may access data stored in the staging tables. Further detail of functionalities provided by staging area 116 are discussed below in further detail in connection with FIG. 2.

After being processed by staging area 116, staging area 116 may transmit the processed data to work area 117. Work area 117 may comprise a memory (not shown) storing program instructions for processing the received data. Processing operations performed by work area 117 may include cleansing, transforming, and grief management functions. For example, work area 117 may cleanse data by removing unnecessary or undesired data elements. Work area 117 may transform data into different data formats and may resolve data for syntax and/or semantics. Work area 117 may provide grief management functions, such as resolving whether two data records having similar names refer to the same entity. Work area 117 may include a work database (not shown), which may store data in work tables. The work tables may comprise data previously processed by work area 117. Data stored in the work tables may be further processed by work area 117 at a later time. Furthermore, applications that are external to data warehouse server 110 may access data stored in the work tables. Further detail of functionalities provided by staging area 116 and work area 117 are discussed below in further detail in connection with FIG. 2.

Once data has been processed by staging area 116 and work area 117, work area 117 may transmit the processed data to database 118 for storage. Applications that are external to data warehouse server 110 may access data stored in database 118. Accordingly, as discussed above, external applications may access data after the data has been processed by staging area 116, work area 117, or after the data is stored in database 118. Such flexibility provides an administrator of system 100 with the option of processing some data by staging area 116 only and making that processed data available to external applications. In such a circumstance, the administrator may wish to save the time and/or expense in having certain data processed by work area 117, but may wish to make the data that was processed by work area 117 available to external applications. However, for other data, the administrator may select to have the data processed by staging area 116 and work area 117.

Servers 120-140 may comprise a general purpose computer (e.g., a personal computer, network computer, server, or mainframe computer) and a database (not shown) for storing data. For example, server 120 may store manufacturing data, server 130 may store sales or accounting data, and server 140 may be associated with an external entity, such as a company or vendor having dealings with the enterprise operating data warehouse server 110. Accordingly, servers 120-140 may constitute any combination of internal an external data sources.

Terminals 150-170 may be any type device for communicating with database server 110 and/or servers 120-140 over network 180. For example, terminals 150-170 may be personal computers, handheld devices, or any other appropriate computing platform or device capable of exchanging data with network 180. Terminals 150-170 may each include a processor and a memory (not shown), for example. Further, terminals 150-170 may execute program modules that provide one or more graphical user interfaces (GUIs) for interacting with network resources. Users may access data over network 180 through a web browser or software application running on any one of terminals 150-170. For example, a web portal may include options for allowing a user to log onto a secure site provided by data warehouse server 110 by supplying credentials, such as a username and a password. Once logged onto the site, the web portal may display a series of screens prompting the user to make various selections to execute a data management tool, discussed below in further detail. In such an implementation, the data management tool may be stored as one or more program modules in memory 114 of data warehouse server 110. Further, since some disclosed embodiments may be implemented using an HTTPS (hypertext transfer protocol secure) environment, data transfer over a network, such as the Internet, may be done in a secure fashion.

In an alternative implementation, instead of using data warehouse server 110 to execute the program that provides the data management tool, any one of terminals 150-170 may execute the program. For example, the program that provides the data management tool may be stored in a memory (not shown) of one or more of terminals 150-170.

In operation, the data management tool may provide functionality for data warehouse 110 to receive data from one or more data sources (e.g., servers 120-140 and/or terminals 150-170). The data management tool may convert, format, and standardize the received data prior to storing it in database 118, as discussed above. Furthermore, the data management tool may classify data into categories, such as company data, unit data, internal data, and external data, for example. Data that has been classified may be stored in an appropriate database (e.g., a staging database, a work database, or database 118) with appropriate attribute values in order to facilitate rapid identification of desired data. Data warehouse server 110 may also consolidate received data by inferring whether data should be associated with other data stored by data warehouse server 110. Data warehouse server 110 may receive data as it is updated by an available data source (e.g., servers 120-140 and/or terminals 150-170) or may receive data on demand; that is, when data warehouse server 110 requests certain data from an available data source. Furthermore, data warehouse server 110 may provide reporting functionality, including functionality for generating insurance reports using data stored in database 118.

FIG. 2 is an exemplary software architecture for implementing data management functionality for data warehouse server 110, consistent with a disclosed embodiment. The software architecture may stored in memory 114 of data warehouse server 110, as shown in FIG. 1, for example, or in memory (not shown) included in one or more of staging area 116 and work area 117. In other embodiments, the software architecture may be stored in, for example, any one of terminals 120-140.

In one embodiment, memory 114 may store instructions of program 214, which when executed, perform one or more data management processes. To do so, program 214 may include instructions in the form of one or more program modules 214a-214e. Program modules 214a-214e may be written using any known programming language, such as C++, XML, etc., and may include an input module 214a, a category module 214b, a formatting module 214c, a storing module 214d, and a reporting module 214e.

Input module 214a may receive data from any one of servers 120-140 and/or terminals 150-170. For example, data warehouse server 110 may receive data from servers 120-140 and/or terminals 150-170 via a batch process that executes on a predetermined schedule (e.g. hourly, daily, etc.). Alternatively, or in addition, data warehouse server 110 may receive data from servers 120-140 and/or terminals 150-170 when data is updated or on demand (i.e., when data warehouse server 110 transmits a request for data). For example, input module 214a may provide functionality for monitoring servers 120-140 and identifying updated or modified data. Furthermore, input module 214a may provide functionality for batch processing of updated data that is received from one or more of servers 120-140, such as at the conclusion of each business day. Data that is received by data warehouse server 110 may be initially processed, for example, by staging area 116.

Category module 214b may determine a category to associate with received data. For example, data may be classified into categories, such as company data, unit data, internal data, and external data, for example. Such categories may be included as metadata associated with data records stored in database 118. “Metadata,” that is, data describing other data, may be associated with received data in order to indicate its source, as well as which units of the company (and any external sources) that are authorized to access the data.

Category module 214b may determine the category for received data based upon identifiers transmitted with the data. For example, data from a particular source may be transmitted in a particular file format (e.g., a flat file) and may include a header designating the source of the data. The header may specify a name, such as a unit of a company or an external source. Upon receipt of the data from one of servers 120-140, category module may read the header, resolve a source name, and use that source name to apply an appropriate category identifier to the received data or to a subset of the received data. Furthermore, external applications may access data processed by category module 214b, such as data stored in a staging database (not shown) of staging area 116.

Formatting module 214c may parse data received from one or more data sources (e.g., servers 120-140 and/or terminals 150-170) and convert the received data into one or more formats appropriate for storage in database 118 of data warehouse server 110. To do so, formatting module 214c may apply one or more logical rules to the data or to a subset of the data. The logical rules may implement, for example, scripts, that convert or process the data or a subset of the data. For example, data warehouse server 110 may be used by a unit of an enterprise, such as a company or an organization having a unit that uses data for a particular purpose. As an example, an enterprise may constitute a company having a unit, such as unit that accesses data of the enterprise to provide insurance products and/or insurance reporting.

Formatting module 214c may analyze received data to determine whether to convert attributes that identify data fields of the received data. For example, metadata may have been created by a unit of the company that stores data in one of servers 120-140. The unit, such as a manufacturing unit, may be responsible for producing products, such a machine (e.g., a fixed and mobile commercial machine, such as a construction machine, fixed engine system, marine-based machine, etc.). The data stored by the manufacturing unit may be suitable for manufacturing purposes, however, the data may not be suitable for other purposes (e.g., insurance reporting purposes). As an example, the data stored in one of servers 120-140 may use metadata that includes codes, shorthand, abbreviations, or designations that may or may not be appropriate or applicable for another unit of the company. Accordingly, formatting module 214c may provide functionality for converting metadata attributes that identify the contents of data fields of the received data.

For example, a look-up table stored in memory 114 may include records storing metadata that is used in the company and may correlate those attributes with attributes that are appropriate for the unit maintaining data warehouse server 110. For example, a manufacturing unit may use metadata, such as a code “XG10” that is associated with a data field to indicate a date that a machine was sold. However, another unit of the company may wish to convert the code “XG10” to “purchase date.” As another example, a code may require conversion because it is misleading or inappropriate for a particular purpose. For example, a unit of the company may use metadata to designate a date of an accident in a database. However, that unit of the company may consider the date of the accident as the date that the accident was reported to the unit. An insurance unit, however, may require the actual date of the accident, which may precede the date that the accident was reported. Accordingly, formatting module 214c may convert metadata, such as a field identifier, for “accident date” to “report date.”

Furthermore, formatting module 214c may provide functionality for verifying the completeness of received data and may also resolve incomplete or incorrect data. For example, formatting module 214c may compare received data to data stored in database 118. As an example, a data record may pertain to an order, and may include a customer name, address, and phone number. However, the customer name may have a typographical error or might be formatted improperly. For example, “John Stevenson” may be listed as “J. Stevenson.” Formatting module 214c may determine to a degree of confidence using, for example, the address, that information pertaining to “J. Stevenson” corresponds to “John Stevenson,” already stored in database 118. Any changes to received data, such as the example provided above, may be stored in a log file in order to provide a record of the change should the change be later deemed incorrect or undesired.

Formatting module 214c may execute routines for verifying the completeness of data and resolving incomplete data based on the category of the data in question. For example, category module 214c, discussed above, may assign a category to received data. Based upon the category, formatting module 214c may execute, for example, scripts that are associated with a particular category. Based on metadata assigned to the received data, formatting module may access, for example, a library defining scripting rules that are applied to a particular category of data. For example, category module 214b may have categorized data received from an accounting department as “accounting data.” The category “accounting data” may have one or more scripts associated with it that are executed by formatting module 214c. For example, formatting module 214c may execute the “accounting data” scripts to match received data with existing accounts in order to resolve any typographical errors or improperly formatted data, as discussed above. The logic (e.g., scripts) may be stored as a library included in database 118, for example. Functionality provided by formatting module 214c may be implemented by, for example, work area 117. Furthermore, external applications may access data processed by formatting module 214c, such as data stored in a work database (not shown) of work area 117.

Storing module 214d may store data in database 118. For example, database 118 may centrally store data received by data warehouse server 110 once it has been appropriately categorized and formatted by category module 214b and formatting module 214c. External applications may access the data stored by storing module 214d in database 118.

Reporting module 214e may generate reports from data stored in database 118 or in a database of staging area 116 and/or work area 117. Reporting module 214e may also generate mock reports for user acceptance testing purposes. For example, reporting module 214e may produce a mock report for a unit of a company, such as an insurance unit. The insurance unit may require data that is formatted in a particular format. The mock report may use mock data, or actual data stored in database 118. Once the mock report has been approved by a user, reporting module 214e may produce an actual report from data stored in database 118 or in a database of staging area 116 and/or work area 117. Furthermore, reporting module 214e may provide functionality for overlaying the mock report with the report that was generated from real data in order to determine whether the report passed or failed.

Although program modules 214a-214e have been described above as being separate modules, one of ordinary skill in the art will recognize that functionalities provided by one or more modules may be combined.

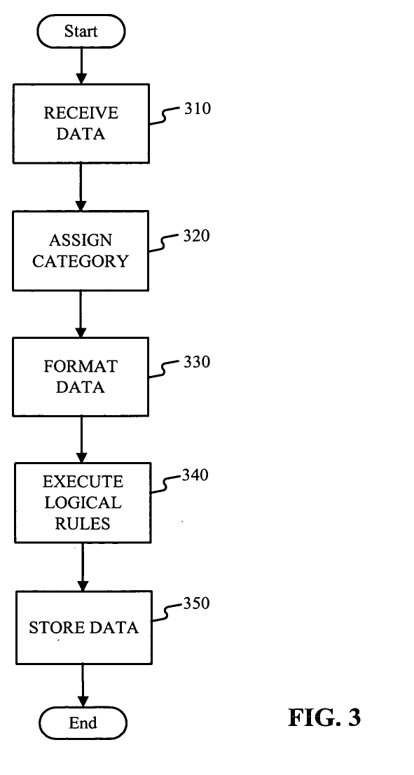

Referring now to FIG. 3, a flow diagram 300 is provided of an exemplary method for implementing data management functionality for data warehouse server 110, consistent with a disclosed embodiment. For example, the method may implement processes according to one or more of program modules 214a-214e.

At the start of the process, in step 310, input module 214a receives data over network 180 for an enterprise. Data may be received on demand or as data is updated by any one of servers 120-140, for example. Data warehouse server 110 may receive data from servers 120-140 and/or terminals 150-170 via a batch process that executes on a predetermined schedule (e.g. hourly, daily, etc.). Alternatively, or in addition, data warehouse server 110 may receive data from servers 120-140 and/or terminals 150-170 when data is updated or on demand (i.e., when data warehouse server 110 transmits a request for data). Data that is imported may be received from multiple data sources, one or more of which may be external to the enterprise. Furthermore, the imported data may be initially processed and stored by staging area 116. The process proceeds to step 320.

Next, in step 320, category module 214b may determine a category for data that was received from a particular source based upon one or more identifiers transmitted with the data. Processing by category module 214b may occur in staging area 116, for example. Using the one or more identifiers transmitted with the data, category module 214b may assign a category identifier to the data or to a subset of the data. For example, the category identifier may identify a data source from which the data or a subset of the data originated, such as company data, unit data, internal data, and external data. The category identifier may allow and/or prevent users at, for example, terminals 150-170 from accessing certain data. In one embodiment, after processing by category module 214b, staging area 116 may transmit the processed data to work area 117 for further processing. In another embodiment, the data may additionally be stored by staging area 116. The process proceeds to step 330.

Next, in step 330, formatting module 214c may convert and format the data. Processing by formatting module 214c may occur in work area 117, for example. For example, in this step, the data may proceed through a first stage in which the data is altered and/or converted by logic, such as a script, that standardizes the data. For example, formatting module may alter attributes that identify data fields of the received data to conform to a particular standard, such as an insurance industry standard. Furthermore, formatting module 214c may determine one or more scripts to apply based upon the category identifier. The process proceeds to step 340.

In step 340, formatting module 214c may execute logic that perform functions such as verification of the completeness of received data and resolution of incomplete or incorrect data. To do so, formatting module 214c may execute scripts for verifying the completeness of data and resolving incomplete data based on the category of the data in question. Furthermore, based upon the category of the data or a subset of the data, formatting module 214c may retrieve and execute scripts stored in a library included in database 118. In one embodiment, after processing by formatting module 214c, work area 117 may transmit the processed data to database 118. In another embodiment, the data may additionally be stored by work area 117. The process proceeds to step 350.

Next, in step 350, storing module 214d stores the data to database 118. Database 118 may centrally store data received by data warehouse server 110 once it has been appropriately classified and formatted by category module 214b and formatting module 214c. After data has been stored by storing module 214d, external applications may access the data. The process then ends.

As one of ordinary skill in the art will appreciate, on or more of steps 310-350 may be optional and may be omitted from implementations in certain embodiments.

Furthermore, as discussed above, after data has been stored in database 118, reporting module 214e may generate reports and/or mock reports for user acceptance testing purposes. For example, reporting module 214e may produce a mock report for a unit of a company, such as an insurance unit. The insurance unit may require data that is in a particular format. The mock report may use test data or actual data stored in database 118, or a database of staging area 116 or work area 117. Once the mock report has been approved by a user, reporting module 214e may produce an actual report from data stored in database 118, or a database of staging area 116 or work area 117. Furthermore, reporting module 214e may provide functionality for overlaying the mock report with the report that was generated from real data in order to determine whether the report is correct (i.e., whether the report has passed or failed) and is ready for use in the enterprise.

### INDUSTRIAL APPLICABILITY

Disclosed embodiments provide data warehouse management functionality for a system including one or more data sources. Disclosed embodiments may categorize, format, and standardize the received data prior to storing it in a database. For example, disclosed embodiments may classify data used by an enterprise into categories, such as company data, unit data, internal data, and external data, for example. Data that has been classified may be stored with appropriate attribute values in order to facilitate rapid identification of desired data. Furthermore, disclosed embodiments provide reporting functionality such that stored data may be used to produce insurance reports. Accordingly, systems and methods consistent with disclosed embodiments provide functionality for automatically converting data from internal and external sources into a standardized format that is suitable for a particular purpose, such as insurance reporting. Furthermore, disclosed embodiments may categorize the data according to its source and use that category to further process the data.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments. For example, the described implementations include software, but systems and methods consistent with the present invention may be implemented as a combination of hardware and software or in hardware alone. Examples of hardware include computing or processing systems, including personal computers, servers, laptops, mainframes, microprocessors and the like. Additionally, although aspects of the invention are described for being stored in memory, one skilled in the art will appreciate that these aspects can also be stored on other types of computer-readable media, such as secondary storage devices, for example, hard disks, floppy disks, or CD-ROM, the Internet or other propagation medium, or other forms of RAM or ROM.

Computer programs based on the written description and methods of this invention are within the skill of an experienced developer. The various programs or program modules can be created using any of the techniques known to one skilled in the art or can be designed in connection with existing software. For example, program sections or program modules can be designed in or by means of Java, C++, HTML, XML, or HTML with included Java applets. One or more of such software sections or modules can be integrated into a computer system or browser software.

Moreover, while illustrative embodiments of the invention have been described herein, the scope of the invention includes any and all embodiments having equivalent elements, modifications, omissions, combinations (e.g., of aspects across various embodiments), adaptations and/or alterations as would be appreciated by those in the art based on the present disclosure. Further, the steps of the disclosed methods may be modified in any manner, including by reordering steps and/or inserting or deleting steps, without departing from the principles of the invention. It is intended, therefore, that the specification and examples be considered as exemplary only, with a true scope and spirit of the invention being indicated by the following claims and their full scope of equivalents.

What is claimed is:

1. A computer-implemented method for managing data for an enterprise, the method comprising:
importing data from a plurality of data sources into a staging area of a server;
processing the data in the staging area, wherein the processing of the data in the staging area comprises:
determining a category identifier for a subset of the data based on one of the plurality of data sources from which the subset of the data originated; and
assigning the category identifier to the subset of the data;
transmitting the subset of the data from the staging area to a work area of the server;
applying, by the work area, one or more logical rules to the subset of the data based on the category identifier, wherein the one or more logical rules convert the subset of the data; and
storing the subset of the data in a database.

2. The method of claim 1, wherein applications that are external to the server may retrieve the subset of the data from the staging area, the work area, or the database.

3. The method of claim 1, wherein at least one of the plurality of data sources is external to the enterprise.

4. The method of claim 1, wherein the category identifier identifies the subset of the data as being one of company data, unit data, internal data, and external data.

5. The method of claim 1, wherein applying the one or more logical rules includes converting one or more identifiers of the subset of data.

6. The method of claim 5, wherein the one or more identifiers are converted into a format that is appropriate for insurance reporting purposes.

7. The method of claim 6, further comprising:
identifying the subset of the data using the category identifier; and
generating a report from the subset of data.

8. The method of claim 1, wherein applying the one or more logical rules includes verifying whether the subset of data is complete.

9. The method of claim 1, wherein applying the one or more logical rules include resolving incomplete or incorrect elements of the subset of data.

10. A system for managing data for an enterprise, the system comprising:
a data warehouse server, the data warehouse server comprising:
a staging area operable to:
import data from a plurality of data sources;
determine a category identifier for a subset of the data based on one of the plurality of data sources from which the subset of the data originated;
assign the category identifier to the subset of the data;
a work area operable to:
receive the subset of the data from the staging area; and
apply one or more logical rules to the subset of the data based on the category identifier, wherein the one or more logical rules convert at least a portion of the subset of the data; and
a database that stores the subset of the data after processing by the staging area and the work area.

11. The system of claim 10, wherein applications that are external to the server may retrieve the subset of the data from the staging area, the work area, or the database.

12. The system of claim 10, wherein at least one of the plurality of data sources is external to the enterprise.

13. The system of claim 10, wherein the category identifier identifies the subset of the data as being one of company data, unit data, internal data, and external data.

14. The system of claim 10, wherein applying the one or more logical rules includes converting one or more identifiers of the subset of data.

15. The system of claim 14, wherein the one or more identifiers are converted into a format that is appropriate for insurance reporting purposes.

16. The system of claim 15, wherein the data warehouse server is further adapted to:
identify the subset of the data using the category identifier; and
generate a report from the subset of data.

17. The system of claim 11, wherein applying the one or more logical rules includes verifying whether the subset of data is complete.

18. The system of claim 11, wherein applying the one or more logical rules include resolving incomplete or incorrect elements of the subset of data.

19. A computer-readable medium storing instructions executable by a processor for managing data for an enterprise according to a method, the method comprising:
importing data from a plurality of data sources into a staging area of a server;
processing the data in the staging area, wherein the processing of the data in the staging area comprises:
determining a category identifier for a subset of the data based on one of the plurality of data sources from which the subset of the data originated; and
assigning the category identifier to the subset of the data;
transmitting the subset of the data from the staging area to a work area of the server;
applying, by the work area, one or more logical rules to the subset of the data based on the category identifier, wherein the one or more logical rules convert the subset of the data; and
storing the subset of the data in a database.

20. The computer-readable medium of claim 19, wherein applications that are external to the server may retrieve the subset of the data from the staging area, the work area, or the database.
